(19) United States
(12) Patent Application Publication
(10) Pub. No.: US 2025/0034950 A1
(43) Pub. Date: Jan. 30, 2025

(54) GREASE WITH NANOPARTICLES FOR TRICONE BITS

(71) Applicant: Caterpillar Inc., Peoria, IL (US)

(72) Inventors: Swetha Suresh, Chennai (IN); Ebi Bernard, Arakkonam (IN); Tamilmurasu Annadurai, Pudukkottai (IN); Hyung Kyu Yoon, Peoria, IL (US)

(73) Assignee: Caterpillar Inc., Peoria, IL (US)

(21) Appl. No.: 18/361,426

(22) Filed: Jul. 28, 2023

(51) Int. Cl. E21B 10/24; C10M 113/08; F16C 33/66; F16C 37/00

(52) U.S. Cl. CPC E21B 10/24; C10M 113/08; F16C 33/6633; F16C 37/007; C10M 2201/0656; C10N 2020/06; C10N 2050/10; F16C 2352/00

(57) ABSTRACT

An air-cooled tricone bit having an air conduit corresponding to individual cones of the tricone bit is filled with lubricant or grease with particles therein is disclosed. The grease may include fullerene-like particles, such as tungsten disulfide, molybdenum disulfide, graphene, graphite, or the like. By packing the air conduit of the tricone bit with the grease with particles, the grease with particles may flow during an initial break-in period of the tricone bit to coat the internal components of the tricone bit. This reduces the friction between the internal components of the tricone bit, such as journal bases, cones, and/or bearing elements. The reduced friction between the internal components of the tricone bit result in reduced wear, both during the break-in period and after the break-in period. The reduced wear results in a greater operating lifetime of the tricone bits.

### TECHNICAL FIELD

The present disclosure relates to bearings for reducing friction between moving parts. More specifically, the present disclosure relates to grease with nanoparticles to lubricate the tricone bits during operation.

### BACKGROUND

Tricone bits are used in a variety of drilling and digging applications, such as mining and mineral retrieval activities. For example, tricone bits may be used to drill deep bores for hydraulic fracturing applications to retrieve oil. Tricone bits include three cones in an assembly with teeth or other cutting surfaces disposed on the three cones. The three cones are each coupled rotatably to a corresponding journal base using one or more bearing components to reduce friction and heat while the cones rotate. During operation, the cones rotate in an intermeshing fashion with each other, and when in contact with the earth, the cones and the teeth thereon cut into dirt, rock, and other minerals. In this way tricone bits dig into the surface of the earth.

During operation, tricone bits are often subject to high levels of pressure and heat. Additionally, the rotation of the tricone bits and the digging process expend a large amount of energy and generate high levels of heat. In this harsh operating environment, the tricone bits experience a high level of wear and tear of its internal components, such as the bearings disposed between the cones and the journal bases. This can reduce the operating lifetime of the tricone bits, resulting in costly downtime of mining and/or oil exploration operations, as well as incurring costs of additional tricone bits. Thus, it is desirable to improve the operating lifetime of the tricone bits by further reducing friction between the cones and the corresponding journal bases.

Additionally, air-cooled tricone bits have advantages over sealed oil cooled tricone bits, such as a more compact form factor and greater load ratings. However, for air-cooled tricone bits, which are open systems not cooled by grease or oil, the operating lifetime can be curtailed due to a lack of lubrication of the internal components of the tricone bits. Therefore, it is particularly desirable to reduce friction within the internal parts of air-cooled tricone bits, which otherwise do not have any persistent lubrication during operation. However, the internal components of the air-cooled tricone bits, such as ball bearings and roller bearings, may be harder to cool compared to lubricant-cooled tricone bits.

One mechanism for lubricating the internal components of a tricone bit is described in U.S. Pat. No. 7,749,947 (hereinafter referred to as “the '947 patent”). The '947 patent describes a tricone bit with a grease reservoir that is filled with lubricant with additives to lubricate bearings of tricone bits during operation. However, the '947 patent uses a more complicated design than an air-cooled tricone bit, where the tricone bit must accommodate a grease reservoir that needs to be refilled during operation. The design of such a tricone bit can be less compact than an air-cooled tricone bit, and all other things being equal, have a lower load rating than air-cooled tricone bits. The presence of the grease reservoir may increase the form factor of the tricone bit and may reduce the overall efficiency of the tricone bit with the grease reservoir.

Examples of the present disclosure are directed toward overcoming one or more of the deficiencies noted above.

### SUMMARY

In an example of the disclosure, a tricone bit assembly includes a first journal base and a first cone rotatably mounted on the first journal base and configured to rotate on a first axis. The tricone bit assembly further includes at least one rolling element disposed between the first journal base and the first cone, such that the at least one rolling element enables the first cone to rotate relative to the first journal base and an air conduit configured to provide air to cool one or more of the first journal base and the at last one rolling element. The tricone bit assembly still further includes composite grease disposed within the air conduit, wherein the composite grease comprises a grease with inorganic fullerene particles.

In another example of the disclosure, a method includes fabricating a first journal base of a tricone bit, the first journal base having a first air conduit disposed therein and fabricating a first cone of the tricone bit. The method further includes assembling the first cone on the first journal base and inserting a composite grease within the first air conduit, the composite grease comprising a grease with fullerene particles.

In yet another example of the disclosure, a tricone bit includes a first journal base having a first air conduit and a first cone rotatably mounted on the first journal base and configured to rotate on a first axis. The tricone bit further includes a second journal base having a second air conduit and a second cone rotatably mounted on the second journal base and configured to rotate on a second axis different from the first axis. The tricone bit still further includes composite grease disposed within the first air conduit and the second air conduit, wherein the composite grease comprises a grease with fullerene particles.

### BRIEF DESCRIPTION OF DRAWINGS

FIG. 1 is a schematic illustration of an example tricone bit, in accordance with example embodiments of the disclosure.

FIG. 2 is a schematic illustration of a journal and bearings of a cone of the tricone bit of FIG. 1, according to example embodiments of the disclosure.

FIG. 3 is a sectional illustration of a tricone assembly with a cross section of one cone of the tricone bit of FIG. 1, according to example embodiments of the disclosure.

FIG. 4 is a flow diagram depicting an example method for fabricating a tricone bit of FIG. 1, according to example embodiments of the disclosure.

### DETAILED DESCRIPTION

Wherever possible, the same reference numbers will be used throughout the drawings to refer to the same or like parts.

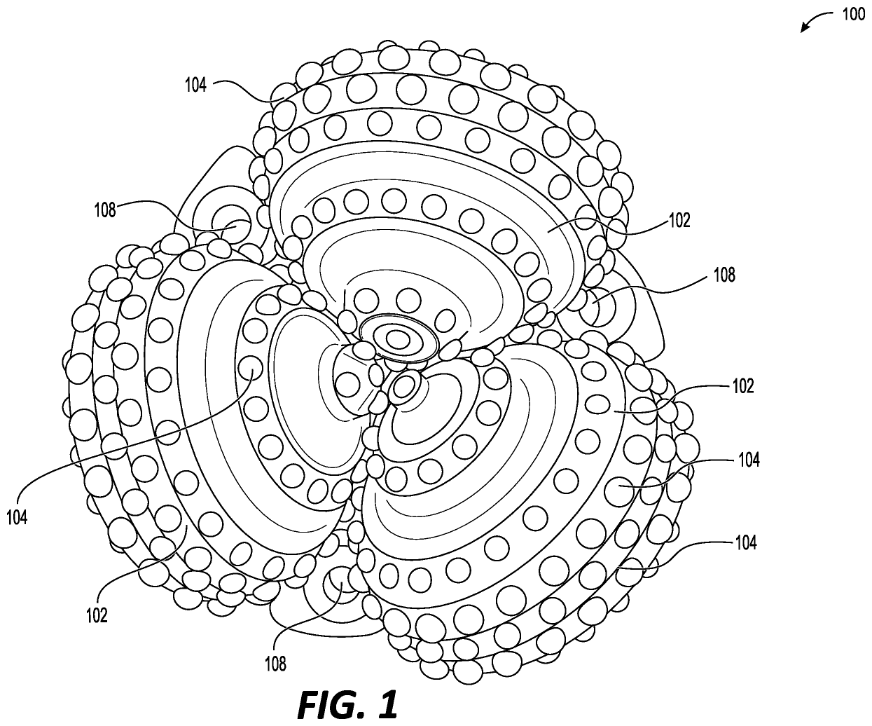

FIG. 1 is a schematic illustration of an example tricone bit 100, in accordance with example embodiments of the disclosure. The tricone bit 100, in some examples, may be an air-cooled tricone bit. In other words, internal components of the tricone bit 100 may be cooled by blown air or blown gas of any type (e.g., nitrogen, dry air, etc.). The tricone bit 100 may be configured for any variety of drilling operations, such as off-shore oil drilling, mineral ore drilling, or the like. The tricone bit 100, as depicted, may be part of an assembly that is mechanically coupled to a rotating shaft that provides rotational coupling during operation.

The tricone bit 100 includes three separate cones 102 that are in proximity to each other. As shown, the cones 102 may be substantially a conical or frustoconical shape and the nose portion of each of the cones 102 may be in greater proximity to each other than the base portion of each of the cones 102. Each of the cones 102 may be configured to rotate independently of each other. As such, one cone 102 may rotate on a first axis of rotation, a second cone 102 may rotate on a second axis of rotation, and a third cone 102 may rotate on a third axis of rotation. The first, second, and third axes are different from each other.

During operation, the three cones 102 rotate and the tricone bit 100 may be pushed, such as by a rotating shaft coupled to the tricone bit 100, against material (e.g., dirt, rock, etc.) that is to be drilled with the tricone bit 100. In this way, the tricone bit 100 is used to remove material during drilling. The tricone bit 100 may be used to drill any suitable materials, such as mineral ores, loose stone, gravel, soil, sand, concrete, dirt, silt, etc. Furthermore, the tricone bit 100 may be used for any suitable activity, such as oil drilling, construction, mining, farming, military, transportation, etc.

The cones 102 may have inserts or teeth 104 disposed on their surface. These teeth 104 allow the tricone bit 100 to cut into hard materials, such as any variety of rocks. As the cones 102 rotate in a manner where the teeth 104 are in contact with the material to be drilled, the teeth 104 dig or scrape into the material to be drilled, thereby removing the material and drilling the hole farther down. Additionally, the teeth 104 may crush drilled material to render that material easier to remove from the hole being drilled.

The cones 102 may be formed using any suitable materials, such as metals. For example, the cones 102 may be formed from steel (e.g., hardened carbon steel). In some cases, the cones may be surface treated to increase their hardness, such as by carburizing, hard facing, or the like. The teeth 104, as embedded within the surface of the cones 102, may be formed from any suitable materials, such as ceramic materials, metals, etc. The teeth 104, for example, may be formed from silicon carbide (SiC), alumina (Al₂O₃), tungsten carbide (WC), various metals, or the like. In some cases, the teeth 104 may be embedded into the surface of the cone 102. In other cases, the teeth 104 may be formed in an integrated fashion with the rest of the cone 102.

The tricone bit 100 may also include one or more blow nozzles 108. These blow nozzles 108 may be adjacent to the cones 102 and may be fluidically coupled to a conduit for pressurized gas. The pressurized gas may be of any suitable type, such as air. During operation, the tricone bit 100 may generate a considerable amount of dust from the material(s) being drilled. The blow nozzles 108 may be used to blow the dust away to clear virgin material to be drilled. In some cases, during operation, the tricone bit 100 may be pushed against the material to be drilled and then pulled away from the material to be drilled, such as in a reciprocating manner. This may be done for various reasons, such as to reduce the thermal load on the tricone bit 100 and its internal components. In some cases, pressurized air may be blown through the blow nozzles 108 as the tricone bit 100 is pulled away from the material to be drilled. In this way, the area to be drilled can be cleared of debris and when the tricone bit 100 reengages the material to be drilled, a virgin surface of that material is available to be drilled, rather than dust obfuscating the surface of the material to be drilled.

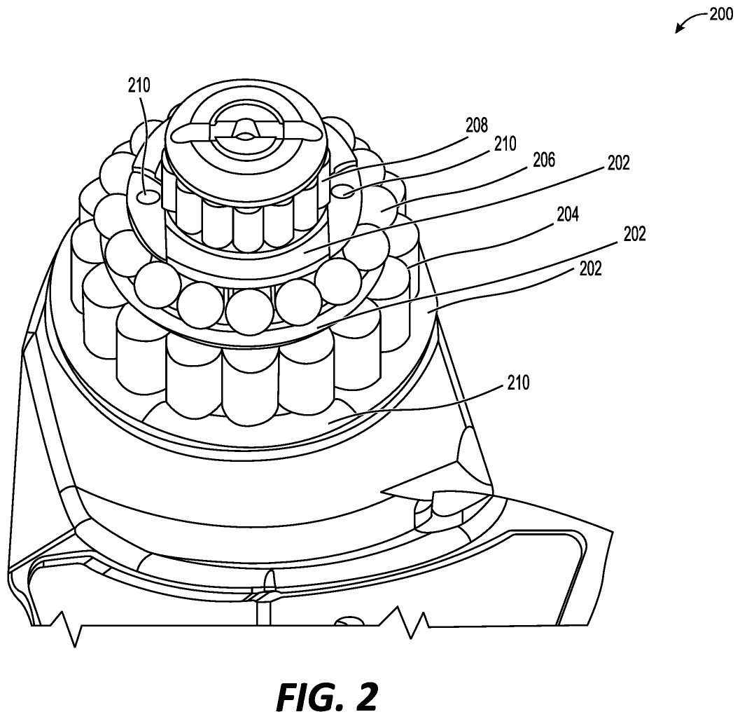

FIG. 2 is a schematic illustration of a journal base 200 and bearings of a cone 102 of the tricone bit of FIG. 1, according to example embodiments of the disclosure. The journal base 200 may include one or more plates 202 to hold the bearing elements 204, 206, 208 of the tricone bit 100. The one or more plates 202 may be separable from the journal base 200 or integrally and/or positionally fixed on the journal base 200. The journal base 200 may further include air slots 210 for cooling the journal base 200, the bearing elements 204, 206, 208, and/or the cone 102.

The journal base 200 may be formed with any suitable material, such as any variety of metals or their alloys. For example, in some cases, the journal base 200 may be substantially formed with hardened steel. The journal base 200 is rotatably coupled to the corresponding cone 102, such that the cone 102 can rotate, while the journal base 200 remains stationary. In other words, the cone 102 rotates around its corresponding journal base 200 during operation of the tricone bit 100. Furthermore, each of the three cones 102 of the tricone bit 100 are configured to rotate around their corresponding journal bases 200 independent of each other. It is this rotational motion of the cone 102 relative to the journal base 200 that allows for the drilling of materials using the tricone bit 100.

The bearing elements 204, 206, 208, are shown as a particular set of stacked components of large rollers 204, balls 206, and small rollers 208. Additionally, the bearing elements 204, 206, 208 together form three separate bearings. However, this is merely an example configuration and example set of rolling elements and number of bearings. It should be understood that this disclosure applies to any suitable type and configuration of bearing elements 204, 206, 208. For example, the features of this disclosure may apply to a journal base 200 with only be two sets of bearings, such as with a set of large rollers and small rollers. Alternatively, the disclosure may apply to a journal base with other types of bearing elements 204, 206, 208, such as journal bearings or other non-rolling bearings. As another example, the tricone bit may include only ball bearings. Further still, the disclosure herein may apply to one or more bearings oriented in an orthogonal (or at another angle) relative to the other bearings of the journal base 200.

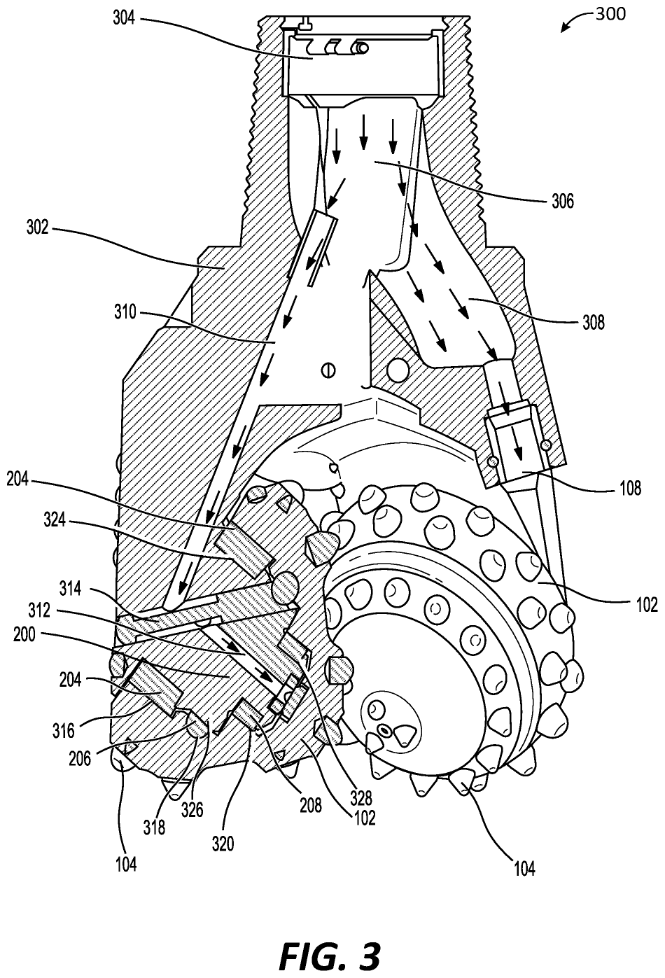

The air slots 210 may be fluidically coupled to a source of pressurized gas, such as pressurized air, as will be described in greater detail in conjunction with FIG. 3. The pressurized gas may be provided from a gas canister/tank, and air compressor, and/or from an air pump. In some cases, the pressurized gas may be a gas other than air or dry air, and air and water mixture and/or and air and oil mixture, to provide greater cooling capacity of the internal components of the tricone bit 100.

The internal components of the tricone bit 100 experience high operating temperatures and high levels of wear and tear, resulting from friction between internal parts of the tricone bit 100, such as the bearing elements 204, 206, and 208 and the journal base 200. It is desirable to have a more advantageous tribology of the internal components of the tricone bit 100. With a more advantageous tribology associated with the internal components of the tricone bits 100, the tricone bits 100 can operate at lower temperatures and experience reduced wear and tear. The disclosure herein provides a mechanism for providing a more advantageous tribology within the tricone bit 100 compared to conventional tricone bits.

FIG. 3 is a schematic illustration of a tricone assembly 300 with a cross section of one cone 102 of the tricone bit 100 of FIG. 1, in according to example embodiments of the disclosure. The tricone assembly 300 may include a housing 302 on which the journal base 200 is disposed. The tricone assembly 300 may further include an air valve 304 to which a source of air or other gases, such as a pressurized canister of gas or an air pump, may be fluidically coupled. Air delivered via the air valve 304 is delivered to an air pathway 306 to be conducted to a first air conduit 308 and a second air conduit 310. The air valve 304 may allow the tricone assembly 300 to be connected to a source of pressurized gas, such as a pressurized air canister (not shown) or a pump. The air valve 304, in some cases, may serve to prevent backflow of air from the tricone bit 100. In other words, the air valve 304 may serve the purpose of only allowing air to flow to the tricone bit 100, rather than from the tricone bit 100.

The first air conduit 308 conducts the air or gas to blow nozzles 108. The second air conduit 310, which conducts gas to a third air conduit 312 within individual ones of the journal base 200, conducts air to the air slots 210 for internal cooling of each of the journal bases 200 and their associated cones 102. As discussed herein, the blow nozzles 108 may be used to blow debris away from the surfaces being drilled. As the tricone bit 100 gets used, the loads on the tricone bit 100 generate heat, such as by friction between the internal components of the tricone bit 100. The air conducted via the air conduit 310 and air conduit 312 and to the air slots 210 cool the internal components (e.g., the journal bases 200, the bearing elements 204, 206, 208, etc.) of the tricone bit 100, such as by convection cooling.

The journal base 200 may also include a retaining pin 314. The retaining pin 314 may be configured to insert the bearing balls 206 between the journal base 200 and the cone 102 via a through-hole of the journal base 200. The retaining pin 314 may further be configured to hold the bearing balls 206 and/or other internal components in place during operation of the tricone bit 100. Thus, the retaining pin 314 may be useful during the fabrication/manufacture of the tricone bit 100 or during the use of the tricone bit 100 or both during the fabrication and use of the tricone bit 100.

The cone 102 may include surfaces 316, 318, 320 adjacent to the bearing elements 204, 206, 208, respectively. These surfaces 316, 318, 320 may serve as raceways (e.g., outer raceway) of bearings formed by the bearing elements 204, 206, 208, respectively. In examples of the disclosure, the surfaces 316, 318, 320 may be coated with grease having particles therein during a break-in period spanning a period of time when the tricone bit 100 is initially used. In some cases, the entire inner surface of the cone 102 may be coated with the grease having particles therein.

The journal base 200 may include surfaces 324, 326, 328 adjacent to the bearing elements 204, 206, 208, respectively. These surfaces 324, 326, 328 may serve as raceways (e.g., inner raceway) of bearings formed by the bearing elements 204, 206, 208, respectively. In examples of the disclosure, the surfaces 324, 326, 328 may be coated with grease having particles therein during the break-in period spanning the period of time when the tricone bit 100 is initially used. In some cases, the entire outer surface of the journal base 200 may be coated with the grease having particles therein.

According to examples of this disclosure, a grease or lubricant with particles, such as nanoparticles, for lubrication in the tricone bit 100 is disclosed. In some cases, the particles in the grease include inorganic fullerene structured materials, such as tungsten disulfide (WS₂). Other materials may include, but are not limited to, molybdenum disulfide (MoS₂), graphite, graphene, bucky balls, other fullerene structures, or the like. The grease with the particles, or composite grease, may be used during an initial break-in period of the bearings of the tricone bit 100. Having this grease with particles during the break-in period leads to reduced friction, wear, and operating temperatures of the tricone bits 100 during operation. In examples of the disclosure, the grease with the particles may be provided in the air conduit 310 of the journal base 200 of the tricone bit 100.

The particles in the grease may be of any suitable size, such as nanometers, tens-of-nanometers, hundreds-of-nanometers, microns, tens-of-microns, or hundreds-of-microns. In one example range, the diameter of the particles suspended in the grease may range from about 1 nanometer to about 1 micron. In one example, the particles may be less than about 10 nanometers in diameter. In some cases, the particle may include tungsten disulfide WS₂. The WS₂ may be sourced or synthesized in any suitable mechanism, such as chemical reactions between metal oxides and sulfides. The WS₂ particles may be of any suitable shape, including tubes or sheets or balls. The WS₂ or other particles, when added to the grease or lubricant, further reduces the friction between the internal components of the tricone bit 100 more than with the grease or lubricant alone. The WS₂ particles may also increase the thermal conductivity of the particle blended grease more than the grease alone, as WS₂ may have greater thermal conductivity than grease. With greater thermal conductivity, more heat can be thermally conducted via the grease with the particles, compared to grease without the particles.

The WS₂ or other particle(s) may be mixed and/or suspended in the grease by any suitable mechanism, such as mixing, stirring, folding, etc. The particle content in the grease may range from about 0.1% by weight to about 50% by weight. In some cases, the particle content in the grease may be in the range of about 0.5% by weight to about 20% by weight. In other cases, the particle content in the grease may be in the range of about 1% by weight to about 10% by weight. In yet other cases, the particle content in the grease may be in the range of about 2% by weight to about 8% by weight. In one example, the particle content in the grease may be approximately 5% by weight.

It should be understood that the grease may include other particles or additives. These additional additives may be any suitable materials, such as metals, ceramics, plastics, or the like. The additional additives may include various base oils, thickening agents, and/or particles other than the inorganic fullerene structured particles disclosed herein. These additives may advantageously alter the thermal conductivity of the grease, the lubricant lifetime of the grease, the tribological properties of the grease, and/or the viscosity of the grease. In some cases, the grease may include more than one fullerene particle. For example, a grease may include both WS₂ and graphene therein, or both MoS₂ and graphite, or the like.

In examples of the disclosure, the air conduit(s) 310, 312 of the tricone bit may be filled with the grease with the particles. In some cases, grease with WS₂ nanoparticles is filled in the air conduits 310, 312. In some cases, when the tricone bit 100 is manufactured, the air conduit 310, 312 may be filled with the grease with the particles, such as by the manufacturer of the tricone bit 100. In other cases, the air conduit 310, 312 may be filled prior to the first (or subsequent) use of the tricone bit 100, such as by the end-user of the tricone bit 100.

The grease with the particles may be in use during an initial break-in period of the tricone bit 100. During this break-in period, the grease with particles may be distributed over the bearing elements 204, 206, 208, the base journal 200, and/or the cone 102. In some cases, during this break-in period, it may not be possible to provide air to the journal base 200 to cool the components thereon. In other cases, it may still be possible, at least in part, to provide blown air to the journal base 200. After the break-in period, the grease with the particles may be clear of the air conduit 310, 312 and air can be blown through the air conduit 310, 312 to cool the journal base 200.

In some cases, the air conduit 310 within the housing 302 of the tricone assembly 300 may be filled with the grease with the particles therein. In other cases, the air conduit 312 within the journal base 200 of the tricone bit 100 may be filled with the grease with the particles therein. In yet other cases, both the air conduit 310 within the housing 302 of the tricone assembly 300 and the air conduit 312 within the journal base 200 of the tricone bit 100 may be filled with the grease with the particles therein.

If the grease with particles is too viscous or even solid at room temperature, it may be difficult to pack the grease with particles into the relatively high aspect ratios of the air conduit 310 and/or air conduit 312. In examples of the disclosure, a heating process may be used to fill the grease with particles within the air conduit 310 and/or air conduit 312. As the grease with particles is heated, it may become less viscous or even liquid, at which point it may be easier to push and/or pour into the air conduit 310 and/or air conduit 312. When the hot or warm grease with particles enters the air conduit 310 and/or air conduit 312, it may cool and become more viscous or even solid. In this way, the grease with particles may be fill in the high-aspect ratio holes of the air conduit 310 and/or air conduit 312. Additionally or alternatively, the grease with particles may be pressurized to inject into the high-aspect ratio holes of the air conduit 310 and/or air conduit 312.

By providing the grease with the particles in the air conduit 310, 312, the grease may be distributed over the components of the journal base 200 and the inner surface of the cone 102 during the break-in period. After the break-in period, the air conduit can be used to provide blown air to cool components of the journal base 200. This design can be used with the air-cooled tricone bits 100, which generally have favorable form-factor, load rating, cone distribution, and/or other superior performance, compared to grease cooled tricone bits with grease reservoirs. Thus, the air-cooled tricone bit 100, as disclosed herein, enables the beneficial properties of air-cooled designs with the lifetime enhancing features of grease cooled designs. This is enabled by the advantageous properties of the particle-laden grease disclosed herein, as well as by using the air conduit(s) 310, 312 as temporary reservoirs of the grease with particles during the initial operation of the tricone bit 100.

When the tricone bit 100 is initially used, such as within the break-in period, the heat generated in the tricone bit 100 from the friction between internal parts (e.g., journal base 200, bearing elements 204, 206, 208, cone 102, etc.) may reduce the viscosity of the grease with particles. The reduced viscosity of the grease with particles may allow the grease with particles to flow within the tricone bit 100. As the grease with particles flows, it coats the journal base 200, bearing elements 204, 206, 208, cone 102 to lubricate those parts and reduce friction therebetween. This coating by the grease with particles may include coating surfaces 316, 318, 320, 324, 326, 328 that serve as raceways within the tricone bit 100. At some point the grease with particles will completely flow out of the air conduits 310, 312, defining the end of the break-in period. However, even after the end of the break-in period, the grease with particles may remain coated on the internal parts, such as the raceways and bearing elements 204, 206, 208 of the tricone bits 100, thereby providing reduced friction between the internal parts of the tricone bit 100.

In some examples, the break-in period may last from about 5 minutes to about 20 hours. In other examples, the break-in period may last from about 10 minutes to about 15 hours. In yet other examples, the break-in period may last from about 30 minutes to about 10 hours. In still other examples, the break-in period may last from about 1 hours to about 7 hours. In one example, the break-in period may last about 5 hours.

In some examples, the lifetime of the air-cooled tricone bit 100 may be improved compared to a conventional air-cooled tricone bit in the range of about 1% to about 100%. In some other examples, the lifetime of the air-cooled tricone bit 100 may be improved compared to a conventional air-cooled tricone bit in the range of about 3% to about 50%. In yet other examples, the lifetime of the air-cooled tricone bit 100 may be improved compared to a conventional air-cooled tricone bit in the range of about 5% to about 20%. In still other examples, the lifetime of the air-cooled tricone bit 100 may be improved compared to a conventional air-cooled tricone bit in the range of about 7% to about 15%. In one example, the lifetime of the air-cooled tricone bit 100 may be improved compared to a conventional air-cooled tricone bit about 10%.

By way of this disclosure, the air-cooled tricone bit 100 operates like a grease-cooled tricone bit for an initial period of operation (e.g., the break-in period). After that initial break-in period, the air-cooled tricone bit 100 operates normally, with blown air circulation and cooling. However, during the post break-in period operation, the internal components of the tricone bit 100 are lubricated with the grease with particles, which reduces friction between the internal components of the tricone bit 100. This enables more persistence of grease, particularly the grease with particles, than conventional air-cooled tricone bits. Thus, the grease with particles, reduces friction and wear of the tricone bit 100 and increases its operating lifetime.

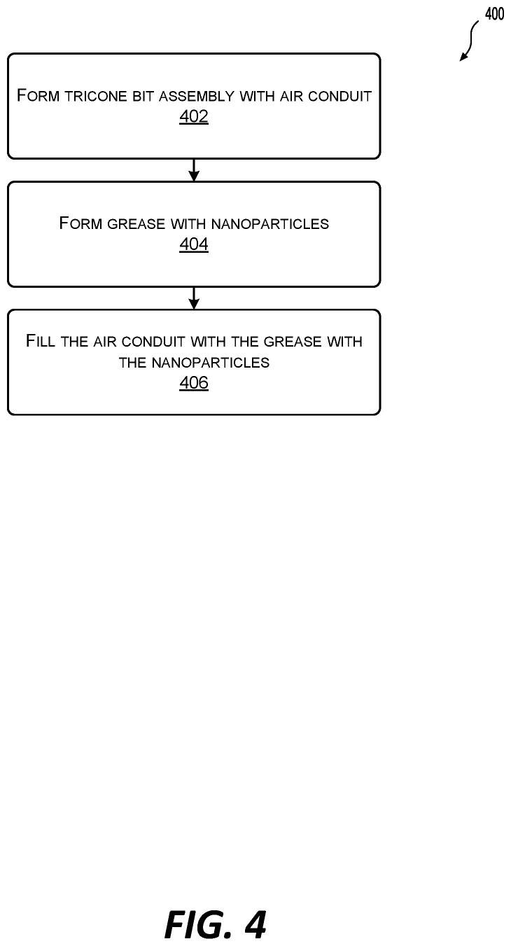

FIG. 4 is a flow diagram depicting an example method 400 for fabricating a tricone bit of FIG. 1, according to example embodiments of the disclosure. The method 400 may be performed by a single entity or multiple entities. As such, portions may be performed by an original equipment manufacturer (OEM) or component manufacturers of the tricone bit 100, as disclosed herein. The tricone bit 100, as disclosed herein, may be an air-cooled tricone bit 100, rather than a closed tricone bit with a grease reservoir. Air-cooled tricone bits 100, as discussed herein may provide certain advantages with respect to load ratings, form factor, the angles of the cones, etc.

At block 402, a tricone bit 100 with air conduit(s) 310, 312 may be fabricated. In some cases, three of each of the cones 102 and journal bases 200 may be formed to assemble one of the tricone bit 100. The cones 102 and/or journal bases 200 may be formed from any suitable material, such as steel, iron, or the like. The cones 102 and/or journal bases 200 may be formed by any suitable mechanism, such as forging, casting, sand casting, extrusion, or the like. The cones 102 may be assembled onto their corresponding journal bases 200 with the bearing elements 204, 206, 208 disposed therebetween.

In some cases, the cones 102 or the journal bases 200 may be treated after formation, such as to provide hard surfaces. For example, the cones and/or journal bases 200 may be formed by steel casting and then undergo a carburization process to increase the carbon content in the surfaces, such as surfaces 316, 318, 320, 324, 326, 328, which may serve as raceways (e.g., inner raceways or outer raceways) of the cones 102 and/or journal bases 200. This allows for hard raceway surfaces, such as the outer surface region of the journal bases 200 and/or the inner surface region of the cones 102, while maintaining a softer core region of the journal bases 200 and/or the cones 102 for relatively high levels of toughness. Other mechanisms for achieving a hard surface region may include hard facing.

In some cases, the journal bases 200 may be fabricated (e.g., sand cast) in an integrated fashion with each other. For example, all three of the journal bases 200 may be formed in a single piece. In some cases, the journal bases 200 may further be fabricated integrally with the housing 302. It should be understood that the processes disclosed herein apply to various ways and partitions of forming the journal bases 200 and/or the cones 102.

At block 404, a grease with nanoparticles therein may be formed. In some cases, the particles in the grease include inorganic fullerene structured materials, such as WS₂. Other materials may include, but are not limited to, MoS₂, graphite, graphene, bucky balls, other fullerene structures, or the like. The particles in the grease may be of any suitable size, such as nanometers, tens-of-nanometers, hundreds-of-nanometers, microns, tens-of-microns, or hundreds-of-microns. In one example range, the diameter of the particles suspended in the grease may range from about 1 nanometer to about 1 micron.

In some cases, the particles may include tungsten disulfide WS₂. The WS₂ may be sourced or synthesized in any suitable mechanism, such as chemical reactions between metal oxides and sulfides. The WS₂ particles may be of any suitable shape, including tubes or sheets or balls. The WS₂ or other particles, when added to the grease or lubricant, further reduces the friction between the internal components of the tricone bit 100 more than with the grease or lubricant alone. The WS₂ particles may also increase the thermal conductivity of the particle blended grease more than the grease alone, as WS₂ may have greater thermal conductivity than grease. With greater thermal conductivity, more heat can be thermally conducted via the grease with the particles, compared to grease without the particles.

The WS₂ or other particle(s) may be mixed and/or suspended in the grease by any suitable mechanism, such as mixing, stirring, folding, etc. The particle content in the grease may range from about 0.1% by weight to about 50% by weight. In some cases, the particle content in the grease may be in the range of about 0.5% by weight to about 20% by weight. In other cases, the particle content in the grease may be in the range of about 1% by weight to about 10% by weight. In yet other cases, the particle content in the grease may be in the range of about 2% by weight to about 8% by weight. In one example, the particle content in the grease may be approximately 5% by weight.

It should be understood that the grease may include other particles or additives. These additional additives may be any suitable materials, such as metals, ceramics, plastics, or the like. The additional additives may include various base oils, thickening agents, and/or particles other than the inorganic fullerene structured particles disclosed herein. These additives may advantageously alter the thermal conductivity of the grease, the lubricant lifetime of the grease, the tribological properties of the grease, and/or the viscosity of the grease. In some cases, the grease may include more than one fullerene particle. For example, a grease may include both WS₂ and MoS₂ therein, or both MoS₂ and graphene, or the like.

At block 406, the air conduit of the tricone bit 100 may be filled with the grease with the nanoparticles therein. In some cases, the air conduit 310 within the housing 302 of the tricone assembly 300 may be filled with the grease with the particles therein. In other cases, the air conduit 312 within the journal base 200 of the tricone bit 100 may be filled with the grease with the particles therein. In yet other cases, both the air conduit 310 within the housing 302 of the tricone assembly 300 and the air conduit 312 within the journal base 200 of the tricone bit 100 may be filled with the grease with the particles therein.

If the grease with particles is too viscous or even solid at room temperature, it may be difficult to pack the grease with particles into the relatively high aspect ratios of the air conduit 310 and/or air conduit 312. In examples of the disclosure, a heating process may be used to fill the grease with particles within the air conduit 310 and/or air conduit 312. As the grease with particles is heated, it may become less viscous or even liquid, at which point it may be easier to push and/or pour into the air conduit 310 and/or air conduit 312. When the hot or warm grease with particles enters the air conduit 310 and/or air conduit 312, it may cool and become more viscous or even solid. In this way, the grease with particles may be fill in the high-aspect ratio holes of the air conduit 310 and/or air conduit 312. Additionally or alternatively, the grease with particles may be pressurized to inject into the high-aspect ratio holes of the air conduit 310 and/or air conduit 312.

By method 400, the grease with the particles may be packed in the air conduit(s) 310, 312 prior to first using the tricone bit 100 or during a break in the use of the tricone bit 100. The grease with particles, such as nanoparticles, may flow during an initial break-in period of the bearings of the tricone bit 100. Having this grease with particles during the break-in period leads to reduced friction, wear, and operating temperatures of the tricone bits 100 during operation. This in turn leads to increased usable lifetimes of the tricone bits 100. While the grease with particles may be used on any type of tricone bit, or generally any type of bearing, the grease with particles are particularly useful for friction reduction in air-cooled tricone bits 100.

It should be noted that some of the operations of method 400 may be performed out of the order presented, with additional elements, and/or without some elements. Some of the operations of method 400 may further take place substantially concurrently and, therefore, may conclude in an order different from the order of operations shown above.

The disclosure is described above with reference to block and flow diagrams of systems, methods, apparatuses, and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some embodiments of the disclosure.

### INDUSTRIAL APPLICABILITY

The present disclosure describes systems and methods for extending the operating lifetime of tricone bits 100, such as air-cooled tricone bits 100. The tricone bits 100, as disclosed herein, include one or more air conduit(s) 310, 312 that is used for supplying cooling air to the bearing elements 204, 206, 208, the journal base 200, and/or the cone 102 within the tricone bits 100. During normal operations of the tricone bit 100, air may be forced into the air conduit(s) 310, 312 and through air slots 210 that provide the air to a journal base 200 and bearing elements 204, 206, 208 disposed on the journal base 210. According to the disclosure herein, initially the air conduit 310 may be filled with grease with particles, such as nanoparticles. The particles may include WS₂ and/or other fullerene-like particles.

The disclosure herein provides a more persistent lubrication for the moving parts (e.g., bearings formed by sandwiching the bearing elements 204, 206, 208 between the cone 102 and the journal base 200) during the operation of the tricone bit. The technological advances presented herein can provide a benefit to any type of tricone bit, such as a sealed grease-cooled tricone bit. However, the advantages of this disclosure may be particularly beneficial for air-cooled tricone bits 100, which conventionally do not have persistent lubrication beyond just an initial greasing prior to first use. Additionally, the system(s) and mechanisms disclosed herein lend themselves to greater thermal efficiencies for not just tricone bits 100, but also bearings for other applications, such as transportation applications.

The tricone bits 100 fabricated according to the disclosure herein provide a supply of grease with particles therein, resulting in reduced friction between components of the tricone bits 100. The grease with particles may flow out of the air conduit(s) 310, 312, during an initial break-in period of the tricone bit 100, and coat the internal components of the tricone bit 100. This results in reducing friction between parts of the tricone bit 100, not only during the break-in period, but also after the break-in period, as the components of the tricone bit 100 are coated with the grease with particles. The reduced friction in tricone bits 100, and/or bearings in general, result in reduced operating temperatures, as well as reduced wear and tear and increased operating lifetimes.

The increased operating lifetimes result in reduced number of tricone bits 100 needed for completing drilling projects. Furthermore, the increased operating lifetimes decrease the need to stop operations of drilling projects to change the tricone bit 100. Thus, the disclosure enables greater uptime of drilling projects and reduced material usage. Therefore, the disclosure results in greater efficiencies and greater return on investment (ROI) and return on capital (ROC) compared to conventionally fabricated tricone bits.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

1. A tricone bit assembly, comprising:
a housing;
a first journal base coupled to the housing;
a first cone rotatably mounted on the first journal base and configured to rotate on a first axis;
at least one rolling element disposed between the first journal base and the first cone, such that the at least one rolling element enables the first cone to rotate relative to the first journal base;
a first air conduit configured to provide air to cool one or more of the first journal base and the at least one rolling element, the first air conduit disposed within the first journal base;
a second air conduit fluidically coupled to the first air conduit and disposed within the housing; and
composite grease disposed within both the first air conduit and the second air conduit, wherein the composite grease comprises a grease with inorganic fullerene particles.

2. The tricone bit assembly of claim 1, wherein the inorganic fullerene particles include tungsten disulfide (WS₂).

3. The tricone bit assembly of claim 1, wherein the inorganic fullerene particles have a diameter less than 10 nanometers.

4. The tricone bit assembly of claim 1, wherein the at least one rolling element comprises at least one of a small roller, a large roller, and a ball.

5. The tricone bit assembly of claim 1, wherein the first air conduit and the second air conduit are configured to provide air to cool the one or more of the first journal base and the at least one rolling element after the first conduit and the second conduit are clear of the composite grease during operation of the tricone bit assembly

6. The tricone bit assembly of claim 1, wherein the inorganic fullerene particles are 2% to 8% by weight of the composite grease.

7. The tricone bit assembly of claim 1, wherein a thermal conductivity of the inorganic fullerene particles is greater than a thermal conductivity of the grease.

8. The tricone bit assembly of claim 1, further comprising:
a second journal base;
a second cone rotatably mounted on the second journal base and configured to rotate on a second axis; and
a third air conduit configured to provide air to cool the second journal base, wherein the composite grease is disposed within the third air conduit.

9. The tricone bit assembly of claim 8, further comprising:
at least one second rolling element disposed between the second journal base and the second cone.

10. The tricone bit assembly of claim 8, further comprising:
a fourth air conduit disposed in the second journal base and fluidically coupled to the third air conduit, wherein the composite grease is disposed within the fourth air conduit.

11. A method, comprising:
fabricating a first journal base of a tricone bit, the first journal base having a first air conduit disposed therein;
fabricating a housing with a second air conduit, the second air conduit fluidically coupled to the first air conduit;
fabricating a first cone of the tricone bit;
assembling the first cone on the first journal base; and
inserting a composite grease within the first air conduit and the second air conduit, the composite grease comprising a grease with fullerene particles.

12. The method of claim 11, further comprising:
heating the composite grease to flow the composite grease into the first air conduit.

13. The method of claim 11, wherein the first air conduit and the second air conduit are configured to provide the composite grease to the first journal base and the first cone.

14. The method of claim 11, wherein the fullerene particles include tungsten disulfide (WS₂).

15. A tricone bit, comprising:
a first journal base having a first air conduit;
a first cone rotatably mounted on the first journal base and configured to rotate on a first axis;
a second journal base having a second air conduit;
a second cone rotatably mounted on the second journal base and configured to rotate on a second axis different from the first axis;
a housing having a third air conduit, the third air conduit fluidically coupled to the first air conduit; and
composite grease disposed within the first air conduit, the second air conduit, and the third air conduit, wherein the composite grease comprises a grease with fullerene particles.

16. The tricone bit of claim 15, wherein the fullerene particles include tungsten disulfide (WS₂).

17. The tricone bit of claim 15, wherein the second air conduit is fluidically coupled to a fourth air conduit, wherein the composite grease is disposed in the fourth air conduit.

18. The tricone bit of claim 15, further comprising:
at least one of a small roller, a large roller, and a ball disposed between the first journal base and the first cone.

19. The tricone bit of claim 15, further comprising:
a third journal base having a fourth air conduit; and
a third cone rotatably mounted on the third journal base and configured to rotate on a third axis different from the first axis or the second axis, wherein the composite grease is disposed within the fourth air conduit.

20. The tricone bit of claim 19, wherein the fourth air conduit is fluidically coupled to a fifth air conduit, wherein the composite grease is disposed in the fifth air conduit.
